(19) United States
(12) Patent Application Publication
(10) Pub. No.: US 2012/0286595 A1
(43) Pub. Date: Nov. 15, 2012

(54) ENHANCED DUAL LIQUID COOLING SYSTEM FOR ELECTRIC MOTOR

(76) Inventor: Debabrata Pal, Hoffman Estates, IL (US)

(21) Appl. No.: 13/105,982

(22) Filed: May 12, 2011

(51) Int. Cl. H02K 9/197; H02K 15/00; H02K 9/22

(52) U.S. Cl. 310/54; 29/596

(57) ABSTRACT

An electric machine includes a rotor within a cavity defined within a stator. A liquid coolant is utilized to cool the stator and rotor. The liquid coolant flows through a gap defined between the stator and the rotor. A second coolant is provided that is contained within a second cavity disposed annularly about the first cavity. Thermal energy is transferred away from the gap by way of the first coolant flowing through the gap and by natural convection of the second liquid coolant within the second cavity. The additional mechanism for transferring heat enhances electric machine operation and provides increased operational capacities.

### BACKGROUND

This disclosure generally relates to a liquid cooled electric motor. More particularly, this disclosure relates to an electric motor including different cooling mediums for cooling different parts of the electric motor.

A liquid cooled electric motor or machine includes a cooling medium that flows within a gap between the stator and rotor. The cooling medium is typically electrically conductive and therefore, the cooling medium is separated from the stator by a sleeve disposed about the rotor. Heat from the stator winding is conducted from the stator through the sleeve and finally to the cooling medium within the sleeve and surrounding the rotor. A thermally conductive compound is provided between the sleeve and the stator to aid in thermal conduction from the stator to the sleeve. Gaps or voids in the thermally conductive compound reduce thermal conduction of heat generated by the stator to the cooling medium contained within the sleeve.

### SUMMARY

A disclosed electric machine includes a rotor within a cavity defined within a stator. A liquid coolant is utilized to cool the stator and rotor. The example liquid coolant is flowed through a gap defined between the stator and the rotor. The example liquid coolant is electrically conductive and constrained to interact with only one of either the stator or the rotor.

Thermal energy produced during operation of the electric machine is conducted through the sleeve disposed within the gap between the stator and the rotor into the liquid coolant. The sleeve is placed in thermal contact with the stator through a thermally conductive adhesive. In some instances voids that lack the thermally conductive material are present. A second coolant is provided that is contained within a second cavity disposed annularly about the first cavity. The second liquid coolant is of a different composition than the first liquid coolant. Heat produced by the stator creates a natural convective flow within the second coolant contained in the second cavity. Thermal energy is therefore transferred away from the gap by way of the first coolant flowing through the gap and against the sleeve and by natural convection of the second liquid coolant within the second cavity. The additional mechanism for transferring heat enhances electric machine operation and provides increased operational capacities.

These and other features disclosed herein can be best understood from the following specification and drawings, the following of which is a brief description.

### BRIEF DESCRIPTION OF THE DRAWINGS

FIG. 1 is a cross sectional view of an example electric machine driving a pump.

FIG. 2 is a perspective view of an interface between an example stator and sleeve.

FIG. 3 is a schematic representation of the interface between the sleeve and the stator.

FIG. 4 is a schematic view of another portion of the interface between the stator and sleeve.

FIG. 5 is an enlarged cross sectional view of a portion of the electric machine.

### DETAILED DESCRIPTION

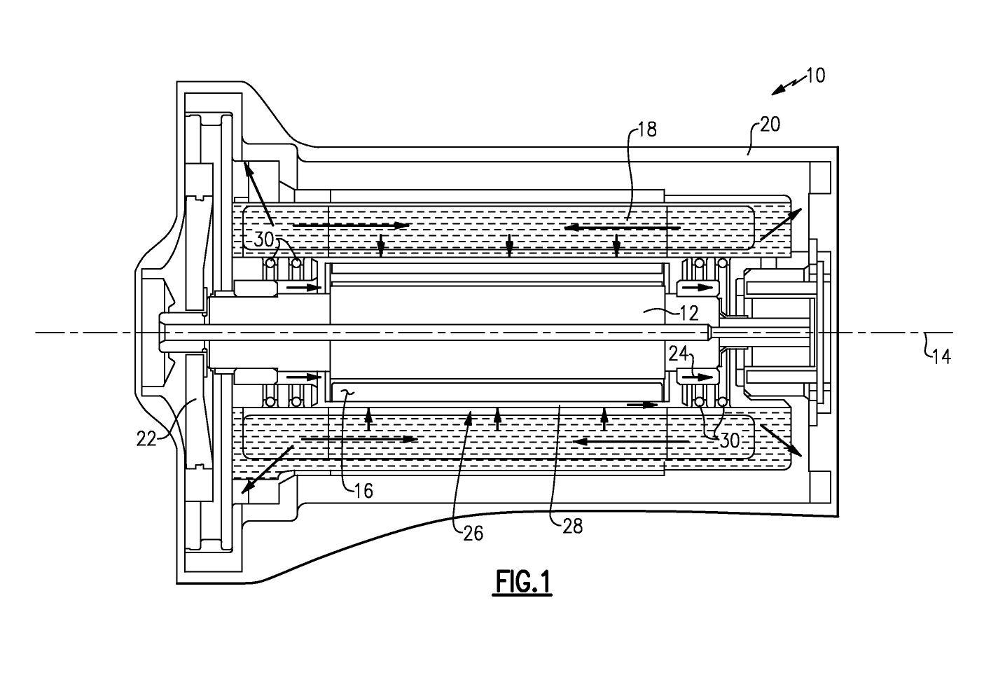

Referring to FIG. 1, an electric machine 10 includes a rotor 12 that rotates about an axis 14 within a cavity defined within a stator 18. The rotor 12 and stator 18 are supported within a housing 20. The example housing 20 also supports a pump 22 that is driven by rotation of the rotor 12. A liquid coolant 24 is utilized to cool the stator 18 and rotor 12. The example liquid coolant 24 is flowed through a gap 26 defined between the stator 18 and the rotor 12. The example liquid coolant 24 is electrically conductive and therefore must be separated and constrained to interact with only one of either the stator 18 or the rotor 12. In this example the liquid coolant 24 comprises approximately 60% water and 40% propylene glycol by volume. However, other liquid coolants as are known are also within the contemplation of this invention. Moreover, although the example electric machine 10 is a motor driving a pump 22, other electric machines such as a generator or electric motor driving another device would also benefit from this disclosure.

The liquid coolant 24 is contained within a cavity 16 defined about the rotor 12. A sleeve 28 is disposed within the gap 26 between the stator 18 and the rotor 12 to contain the electrically conductive coolant about the rotor 12 assembly.

Thermal energy produced during operation of the electric machine 10 is conducted through the sleeve 28 disposed within the gap 26 between the stator 18 and the rotor 12 into the liquid coolant 24. The liquid coolant 24 flows about the rotor 12 and is constrained within the first cavity 16 defined by the sleeve 28. The sleeve 28 is sealed by o-rings 30 that are disposed on each end of the rotor 12. Because the liquid coolant 24 is constrained about the rotor 12, heat generated by the stator 18 must pass through the gap 26 and the sleeve 28 before reaching the liquid coolant 24.

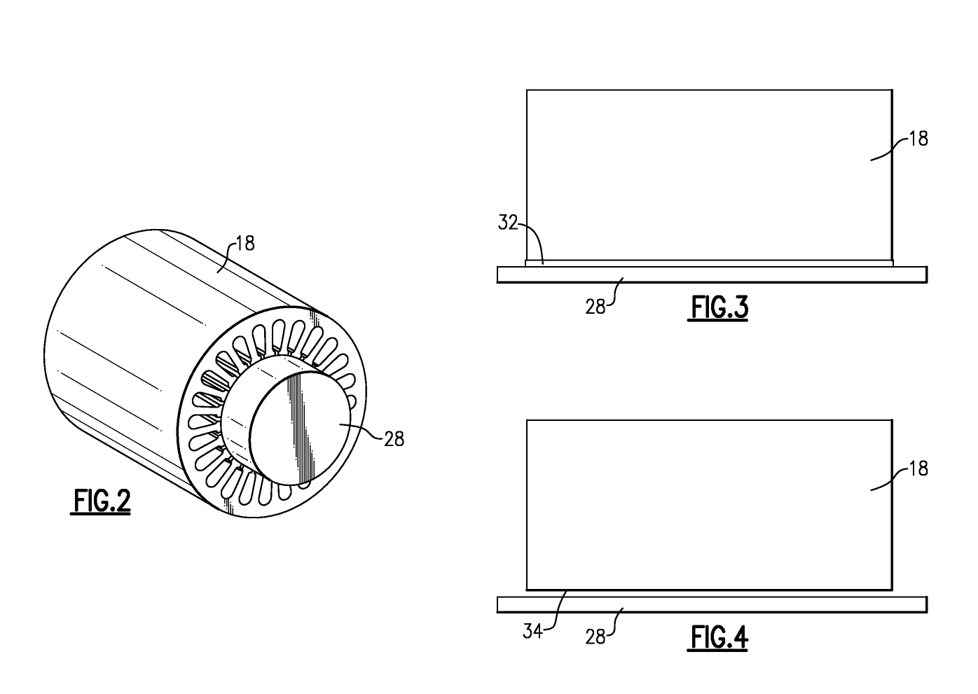

Referring to FIG. 2, the sleeve 28 is placed in thermal contact with the stator 18 through a thermally conductive adhesive 32. This thermally conductive adhesive 32 provides the thermal path between the stator 18 and the sleeve 28. In this example, the thermally conductive adhesive 32 is an impregnation compound RHAD; however, other thermally conductive compounds as are known are also within the contemplation of this disclosure.

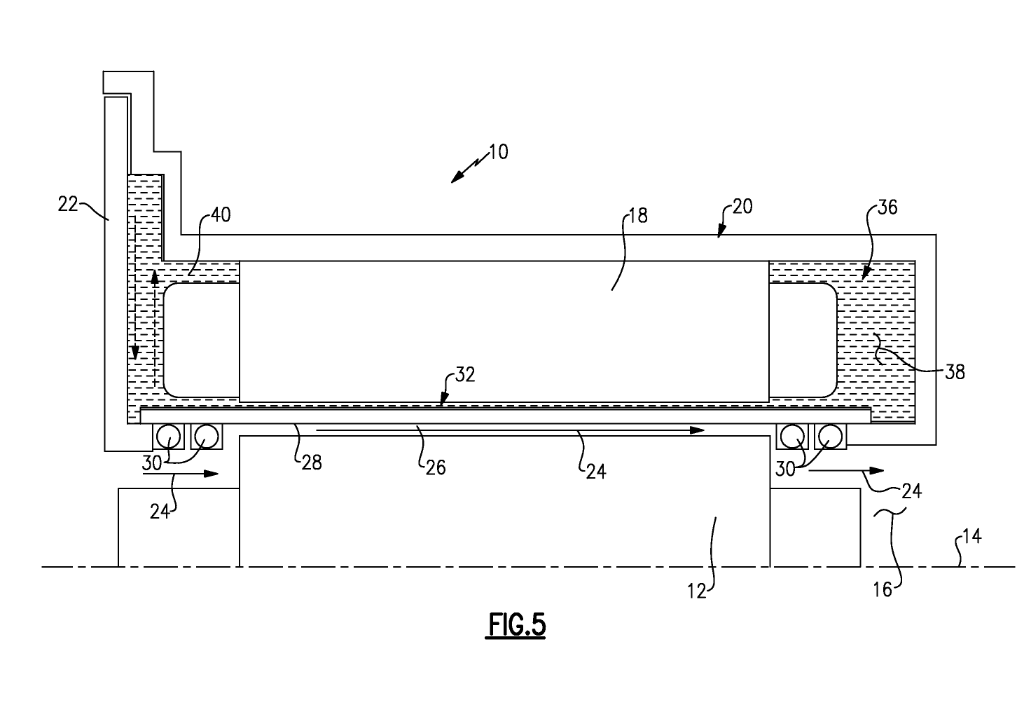

Referring to FIGS. 3 and 4 with continued reference to FIG. 2, the sleeve 28 is in thermal contact with the stator 18 through the thermally conductive material 32. In some instances thermally conductive material 32 is not evenly or consistently spread along the entire axial and annular length of the interface between the stator 18 and the sleeve 28. As is shown in FIG. 4, in some instances voids 34 that lack the thermally conductive material 32 are present. The voids 34 that do not include thermally conductive material 32 define an air gap between the stator 18 and the sleeve 28. This air gap is thermally inefficient and therefore does not conduct the thermal energy and heat generated by the stator 18 as efficiently as the thermally conductive material 32 between and into the sleeve 28 and finally into the liquid coolant 24 within the first cavity 16 defined within the sleeve 28. This results in overheated stator windings, thus reducing reliability of the electric machine.

Referring to FIG. 5, the example electric machine 10 includes a second coolant 38 contained within a second cavity 36 disposed annularly about the first cavity 16. The second liquid coolant 38 is of a different composition than the first liquid coolant 24. The second cavity 36 is defined by the sleeve 28. However the second cavity 36 is defined about an outer surface of the sleeve 28 in contrast to the first cavity 16 that is defined within an interior space of the sleeve 28. The first and second coolants 24, 38 are separated by the cavities 16, 36 defined by the sleeve 28.

The second coolant 38 is a dielectric material such as PAO or MIL-L-23699 oil and provides a thermally conductive interface between the stator 18 and the sleeve 28 in the voids 34. Voids 34 between the stator 18 and sleeve 28 are filled by the second coolant 38 and therefore, air gaps are no longer present between the sleeve 28 and stator 18 and heat may more efficiently transfer between the stator 18 and the sleeve 28. In addition, this method allows for elimination of the RHAD compound application process needed between the stator sleeve 28 and stator 18. The stator sleeve 28 can then be inserted by a press-fit (interference fit) within the stator assembly, thus reducing the cost of manufacturing.

Heat produced by the stator 18 creates a natural convective flow, shown schematically by arrows 40, within the second coolant 38 within the second cavity 36. The second coolant 38 flows outwardly from the hottest areas adjacent the sleeve 28 toward the outer portion of the housing 20. As the second coolant 38 cools, it flows back toward the interface between the sleeve 28 and stator 18. The natural convective flow 40 of the second liquid coolant 38 enhances thermal conduction and cooling of the electric machine 10.

In another example, the second coolant 38 is a solid-liquid phase change material (PCM) such as organic paraffin. The PCM is selected to have a melting point corresponding with operational temperatures of the electric machine 10. As the electric machine 10 approaches the selected melting point, the PCM in solid form will melt and fill any voids 34. As the electric machine 10 returns to normal operational temperatures, the PCM returns to solid form. The PCM will remain in solid form during operation of the electric machine 10 in normal temperature ranges.

Accordingly, thermal energy is transferred away from the gap 26 by way of the first coolant 24 flowing through the gap 26 and against the sleeve 28 and by natural convection of the second liquid coolant 38 within the second cavity 36. The additional mechanism for transferring heat enhances electric machine operation and provides increased operational capacities.

Although an example embodiment has been disclosed, a worker of ordinary skill in this art would recognize that certain modifications would come within the scope of this disclosure. For that reason, the following claims should be studied to determine the scope and content of this invention.

What is claimed is:

1. An electric machine comprising:
a stator defining an inner cavity;
a rotor rotatable about an axis within the inner cavity, the rotor separated from the stator by an annular gap;
a sleeve disposed about the rotor and within the annular gap, the sleeve defining a first sealed chamber including the rotor;
a first cooling medium disposed within the first sealed chamber; and
a second cooling medium disposed outside of the first sealed chamber and about the stator.

2. The electric machine as recited in claim 1, wherein the annular gap includes a first portion between the stator and the sleeve filled with a thermally conductive compound.

3. The electric machine as recited in claim 2, wherein the thermally conductive compound between the stator and the sleeve includes voids absent of thermally conductive compound that are filled with the second cooling medium.

4. The electric machine as recited in claim 2, wherein the annular gap includes a second portion between the rotor and the sleeve with the first cooling medium flowing through the second portion of the annular gap.

5. The electric machine as recited in claim 1, wherein an interface between the stator and the sleeve comprises a press fit and any voids between the sleeve and stator are filled with the second cooling medium.

6. The electric machine as recited in claim 1, wherein the first cooling medium comprises a thermally and electrically conductive liquid.

7. The electric machine as recited in claim 1, wherein the second cooling medium comprises a dielectric cooling medium.

8. The electric machine as recited in claim 7, wherein the dielectric cooling medium comprises a liquid.

9. The electric machine as recited in claim 7, wherein the second cooling medium comprises a solid-liquid phase change material.

10. The electric machine as recited in claim 1, wherein the stator and rotor are mounted within a housing that defines a portion of a second sealed chamber disposed about the first sealed chamber.

11. The electric machine as recited in claim 10, wherein the second sealed chamber is disposed annularly about the first sealed chamber.

12. A pump assembly comprising:
a pump supported within a housing; and
an electric machine to drive the pump and supported within a common housing, the electric machine comprising:
a stator defining an inner cavity;
a rotor rotatable about an axis within the inner cavity, the rotor separated from the stator by an annular gap;
a sleeve disposed about the rotor and within the annular gap, the sleeve defining a sealed chamber including the rotor;
a first cooling medium disposed within the sealed chamber; and
a second cooling medium disposed outside of the sealed chamber and about the stator.

13. The pump assembly as recited in claim 12, wherein the annular gap includes a first portion between the stator and the sleeve filled with a thermally conductive compound.

14. The pump assembly as recited in claim 13, wherein the thermally conductive compound between the stator and the sleeve includes voids absent of thermally conductive compound that are filled with the second cooling medium.

15. The pump assembly as recited in claim 12, wherein the second cooling medium comprises a dielectric cooling medium.

16. A method of installing an electric motor comprising the steps of:
mounting a stator and rotor within a sealed housing, with the stator and rotor separated by an annular gap;
defining a first sealed chamber within which is disposed the rotor;
filling the first sealed chamber with a first cooling medium;
defining a second sealed chamber about the first sealed chamber containing the stator;
filling the second sealed chamber with a second cooling medium comprising at least one of a solid and a liquid; and
mounting the sealed housing to a structure and engaging a driven member of the electric motor with a desired device.

17. The method as recited in claim 16, including the step of defining the first sealed chamber with a sleeve and providing a thermally conductive compound between the stator and the sleeve.

18. The method as recited in claim 17, wherein the thermally conductive compound includes voids that are at least partially filed with the second cooling medium.

19. The method as recited in claim 16, wherein the second cooling medium comprises a dielectric material.
